(19) United States
(12) Patent Application Publication
(10) Pub. No.: US 2022/0082818 A1
(43) Pub. Date: Mar. 17, 2022

(54) OPTICAL ELEMENT, OPTICAL SCANNING APPARATUS, AND IMAGE FORMING APPARATUS

(71) Applicant: TOSHIBA TEC KABUSHIKI KAISHA, Tokyo (JP)

(72) Inventor: Yasushi KURIBAYASHI, Mishima Shizuoka (JP)

(73) Assignee: TOSHIBA TEC KABUSHIKI KAISHA, Tokyo (JP)

(21) Appl. No.: 17/020,144

(22) Filed: Sep. 14, 2020

(51) Int. Cl. G02B 26/12; B41J 2/47

(52) U.S. Cl. CPC G02B 26/125; B41J 2/471

(57) ABSTRACT

An optical element includes an optical surface for giving an optical effect to a light beam that passes therethrough. The optical surface includes a first region and a second region. The first region and the second region are smoothly continuous with each other. The optical surface has an absolute value of a maximum curvature at a boundary between the first region and the second region. The absolute value of the maximum curvature is smaller than a predetermined value.

### FIELD

Embodiments of the present invention relate to an optical element, an optical scanning apparatus, and an image forming apparatus.

### BACKGROUND

An electrophotographic image forming apparatus scans a light beam to form an electrostatic latent image on a photosensitive body. The image forming apparatus includes an optical scanning apparatus that scans the light beam. The optical scanning apparatus includes an optical element that forms an image of the light beam on the photosensitive body.

### DESCRIPTION OF THE DRAWINGS

FIG. 1 is a view illustrating a schematic configuration of an image forming apparatus according to at least one embodiment;

FIG. 2 is a view illustrating a schematic configuration of an image forming section in FIG. 1;

FIG. 3 is a view illustrating an example of an optical scanning apparatus in FIG. 1;

FIG. 4 is a view in which an example of an optical system of the optical scanning apparatus in FIG. 1 is developed on a plane;

FIG. 5 is a perspective view of an optical element applicable to an fθ lens illustrated in FIGS. 3 and 4;

FIG. 6 is a plan view of the optical element illustrated in FIG. 5;

FIG. 7 is a view illustrating a shape of an optical surface at a center portion of the optical element illustrated in FIG. 5;

FIG. 8 is a view illustrating a shape of the optical surface at an end portion of the optical element illustrated in FIG. 5;

FIG. 9 is a sectional view of a center portion of a molding die for manufacturing the optical element in FIG. 5 by molding;

FIG. 10 is a sectional view of the end portion of the molding die for manufacturing the optical element in FIG. 5 by molding;

FIG. 11 is a plan view of an optical element according to another example;

FIG. 12 is a plan view of an optical element according to another example; and

FIG. 13 is a plan view of an optical element according to another example.

### DETAILED DESCRIPTION

An optical element according to at least one embodiment includes an optical surface for giving an optical action to a light beam that passes therethrough. The optical surface includes a first region and a second region. The first region and the second region are smoothly continuous with each other. The optical surface has an absolute value of a maximum curvature at a boundary between the first region and the second region. The absolute value of the maximum curvature is smaller than a predetermined value.

An optical scanning apparatus of at least one embodiment includes: a light source that emits a light beam; an optical scanner that scans the emitted light beam within a plane; and an image forming optical system that forms an image of the scanned light beam. The image forming optical system includes at least one optical element. The optical element includes an optical surface for giving an optical action to a light beam that passes therethrough. The optical surface includes a first region and a second region. The first region and the second region are smoothly continuous with each other. The optical surface has an absolute value of a maximum curvature at a boundary between the first region and the second region. The absolute value of the maximum curvature is smaller than a predetermined value.

An image forming apparatus of at least one embodiment includes: a light source that emits a light beam; an optical scanner that scans the emitted light beam within a plane; an image forming optical system that forms an image of the scanned light beam; and an image forming section that forms an image on an image forming medium based on the imaged light beam. The image forming optical system includes at least one optical element. The optical element includes an optical surface for giving an optical action to a light beam that passes therethrough. The optical surface includes a first region and a second region. The first region and the second region are smoothly continuous with each other. The optical surface has an absolute value of a maximum curvature at a boundary between the first region and the second region. The absolute value of the maximum curvature is smaller than a predetermined value.

Hereinafter, the image forming apparatus according to at least one embodiment will be described with reference to the drawings. In each drawing used in the following description of at least one embodiment, there is a case where the scale of each part is appropriately changed. Where like elements are used in multiple drawings, the description thereof may be omitted in the description of particular embodiment(s).

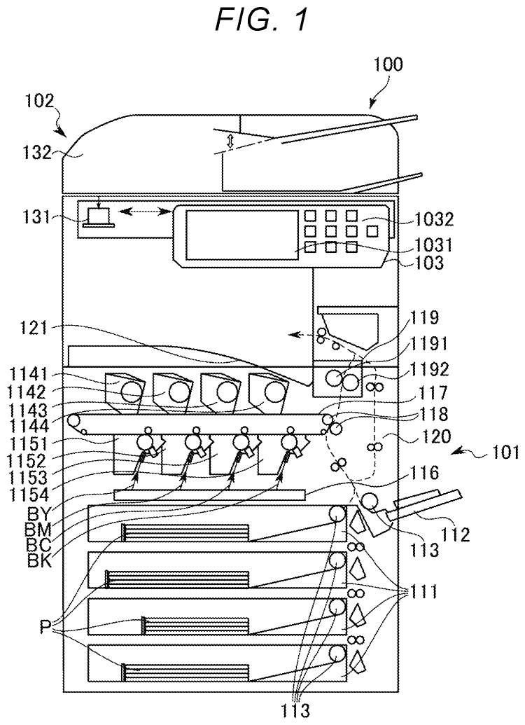

FIG. 1 illustrates a schematic configuration of an image forming apparatus 100 according to at least one embodiment. The image forming apparatus 100 is an apparatus including a printing function, such as a multifunction peripheral (MFP), a copying machine, a printer, or a facsimile for example. However, the image forming apparatus 100 will be described below as an MFP.

The image forming apparatus 100 has, for example, a printing function, a scanning function, a copying function, a color fading function, a facsimile function, and the like. The printing function is a function of forming an image on an image forming medium P or the like using a recording material such as toner. The image forming medium P is, for example, sheet-like paper or the like. The scanning function is a function of reading an image from a document or the like on which an image is formed. The copying function is a function of printing an image read from the document or the like using the scanning function on the image forming medium P using the printing function. The color fading function is a function of fading the color of the image formed on the image forming medium P by a recording material of which the color can be faded.

The image forming apparatus 100 includes a printer 101, a scanner 102, and an operation panel 103.

The printer 101 is an apparatus having a printing function. The printer 101 includes a paper feed tray 111, a manual feed tray 112, a paper feed roller 113, four toner cartridges 1141, 1142, 1143, and 1144, four image forming sections 1151, 1152, 1153, and 1154, an optical scanning apparatus 116, a transfer belt 117, a secondary transfer roller 118, a fixing section 119, a double-side unit 120, and a paper discharge tray 121.

The paper feed tray 111 accommodates the image forming medium P used for printing.

The manual feed tray 112 is a stand for manually inserting the image forming medium P.

The paper feed roller 113 is rotated by a motor, and accordingly, the image forming media P accommodated in the paper feed tray 111 and the manual feed tray 112 are selectively conveyed out from the paper feed tray 111 and the manual feed tray 112.

The toner cartridges 1141 to 1144 store recording materials supplied to the image forming sections 1151 to 1154, respectively. For example, the recording material is a toner. The toner cartridge 1141 stores a yellow (Y) recording material. The toner cartridge 1142 stores a magenta (M) recording material. The toner cartridge 1143 stores a cyan (C) recording material. The toner cartridge 1144 stores a black (K) recording material. The combination of the colors of the recording material is not limited to CMYK, and other colors may be combined. The recording material may be a recording material that fades color at a temperature higher than a predetermined temperature.

The image forming sections 1151 to 1154 receive recording materials supplied from the toner cartridges 1141 to 1144, respectively, and form images of different colors. The image forming section 1151 forms a yellow (Y) image. The image forming section 1152 forms a magenta (M) image. The image forming section 1153 forms a cyan (C) image. The image forming section 1154 forms a black (K) image.

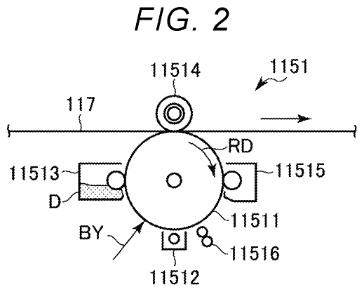

The image forming sections 1151 to 1154 have the same configuration except the difference in the recording material. Here, the image forming section 1151 will be representatively described with reference to FIG. 2. FIG. 2 is a schematic view illustrating a schematic configuration of the image forming section 1151.

The image forming section 1151 includes a photoreceptor drum 11511, a charging unit 11512, a developing unit 11513, a primary transfer roller 11514, a cleaner 11515, and a charge removal lamp 11516.

The photoreceptor drum 11511 is irradiated with a light beam BY emitted from the optical scanning apparatus 116. Accordingly, an electrostatic latent image is formed on the surface of the photoreceptor drum 11511.

The charging unit (e.g., charger) 11512 charges surface of the photoreceptor drum 11511 with a predetermined positive charge.

The developing unit (e.g., developer) 11513 develops the electrostatic latent image of the surface of the photoreceptor drum 11511 using a recording material D supplied from the toner cartridge 1141. Accordingly, an image is formed by the recording material D on the surface of the photoreceptor drum 11511.

The primary transfer roller 11514 is disposed at a position opposing the photoreceptor drum 11511 with the transfer belt 117 interposed therebetween. The primary transfer roller 11514 generates a transfer voltage between the primary transfer roller 11514 and the photoreceptor drum 11511. Accordingly, the primary transfer roller 11514 transfers (primarily transfers) the image formed on the surface of the photoreceptor drum 11511 onto the transfer belt 117 that is in contact with the photoreceptor drum 11511.

The cleaner 11515 removes the recording material D remaining on the surface of the photoreceptor drum 11511.

The charge removal lamp 11516 removes the electric charge remaining on the surface of the photoreceptor drum 11511.

In FIG. 1, the optical scanning apparatus 116 is also called a laser scanning unit (LSU) or the like. The optical scanning apparatus 116 irradiates the image forming sections 1151, 1512, 1513, and 1154 with the light beams BY, BM, BC, and BK, respectively, according to the input image data. The light beams BY, BM, BC, and BK are for forming images of Y, M, C, and K colors, respectively. The optical scanning apparatus 116 controls the light beam BY according to the Y component of the image data to form an electrostatic latent image on the surface of the photoreceptor drum 11511 of the image forming section 1151. Similarly, the optical scanning apparatus 116 controls the light beams BM, BC, and BK according to the M, C, and K components of the image data to form an electrostatic latent image on the surface of the photoreceptor drum of the image forming sections 1152, 1153, and 1154.

The input image data is, for example, image data read from a document or the like by the scanner 102. Otherwise, the input image data is image data transmitted from another apparatus or the like and received by the image forming apparatus 100.

The transfer belt 117 is, for example, an endless belt, and can be rotated by the action of a roller. The transfer belt 117 is rotated to convey the image transferred from the image forming sections 1151 to 1154 to the position of the secondary transfer roller 118.

The secondary transfer roller 118 includes two rollers opposing each other. The secondary transfer roller 118 transfers (secondarily transfers) the image formed on the transfer belt 117 onto the image forming medium P passing between the secondary transfer rollers 118.

The fixing section 119 heats and pressurizes the image forming medium P to which the image is transferred. Accordingly, the image transferred onto the image forming medium P is fixed. The fixing section 119 includes a heating section 1191 and a pressure roller 1192 opposing each other.

The heating section 1191 is, for example, a roller including a heat source for heating the heating section 1191. The heat source is, for example, a heater. The roller heated by the heat source heats the image forming medium P.

The pressure roller 1192 pressurizes the image forming medium P passing between the pressure roller 1192 and the heating section 1191.

The double-side unit 120 puts the image forming medium P into a state where printing on the back surface is possible. For example, the double-side unit 120 reverses the front and back of the image forming medium P by switching back the image forming medium P using a roller or the like.

The paper discharge tray 121 is a stand on which the image forming medium P for which printing is completed is discharged.

The scanner 102 is an apparatus having a scanning function. The scanner 102 is, for example, an optical reduction system including an image element such as a charge-coupled device (CCD) image sensor. Otherwise, the scanner 102 is a contact image sensor (CIS) type including an image element such as a complementary metal-oxide-semiconductor (CMOS) image sensor. Otherwise, the scanner 102 may be any other known type. The scanner 102 reads an image from a document or the like. The scanner 102 includes a reading module 131 and a document sending apparatus 132.

The reading module 131 converts the incident light into a digital signal by an image sensor. Accordingly, the reading module 131 reads an image from the surface of the document.

The document sending apparatus 132 is also called, for example, an auto document feeder (ADF). The document sending apparatus 132 successively conveys a document placed on the tray for document sending. The image of the conveyed document is read by the scanner 102. The document sending apparatus 132 may include a scanner for reading an image from the back surface of the document. The surface of which the image is read by the scanner 102 is the front surface.

The operation panel 103 includes a man-machine interface that performs input and output between the image forming apparatus 100 and an operator of the image forming apparatus 100, or the like. The operation panel 103 includes, for example, a touch panel 1031 and an input device 1032.

The touch panel 1031 is, for example, a stack of a display, such as a liquid crystal display or an organic EL display, and a pointing device by touch input. The display included in the touch panel 1031 functions as a display device that displays a screen for notifying the operator of the image forming apparatus 100 of various pieces of information. The touch panel 1031 functions as an input device that receives a touch operation by the operator.

The input device 1032 receives an operation by the operator of the image forming apparatus 100. The input device 1032 is, for example, a keyboard, a keypad, a touchpad, or the like.

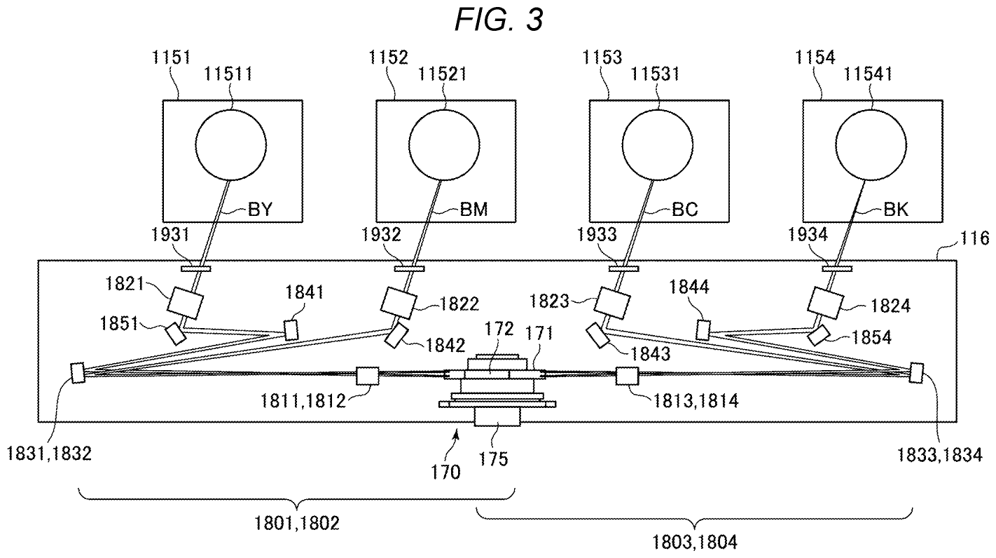

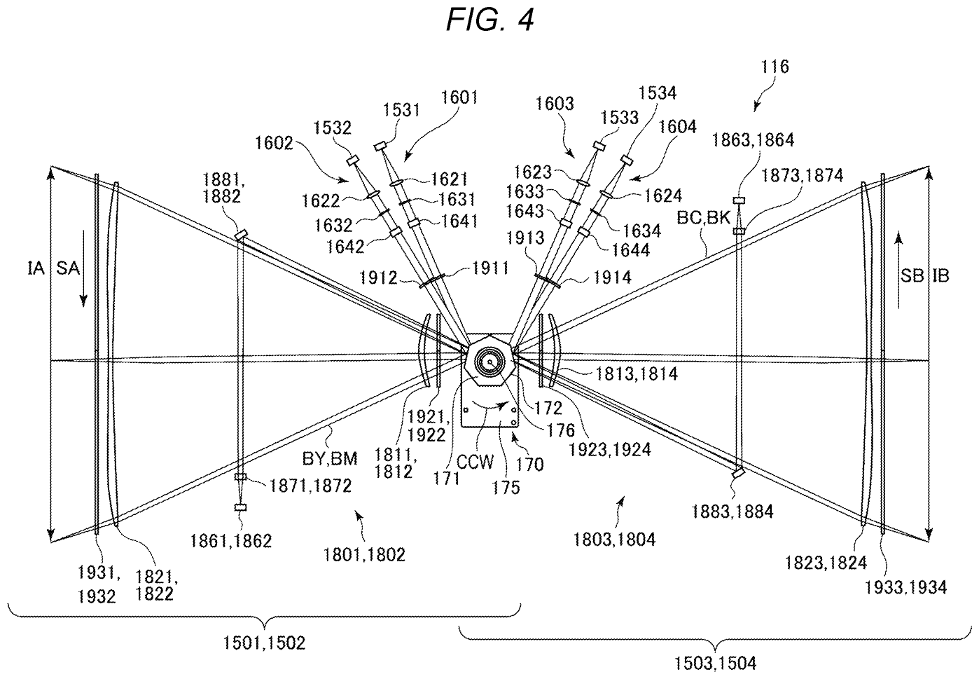

The optical scanning apparatus 116 will be further described with reference to FIGS. 3 and 4. FIG. 3 is a view illustrating an example of the optical scanning apparatus 116. FIG. 4 illustrates an example of an optical system of the optical scanning apparatus 116 is developed on a plane.

The optical scanning apparatus 116 includes four light sources 1531, 1532, 1533, and 1534 and an optical scanner 170.

The light sources 1531, 1532, 1533, and 1534 emit the light beams BY, BM, BC, and BK, respectively.

The optical scanner 170 dynamically deflects the light beams BY, BM, BC, and BK emitted from the light sources 1531, 1532, 1533, and 1534 to scan the light beams BY, BM, BC, and BK.

For example, the optical scanner 170 is configured with a polygon mirror scanner and includes a polygon mirror 171 and a motor 175.

The polygon mirror 171 is a regular polygonal prismatic mirror of which each side surface is a reflective surface 172. The polygon mirror 171 illustrated in FIGS. 3 and 4 is a regular heptagonal prismatic mirror including seven reflective surfaces 172. The polygon mirror 171 can rotate around a rotation axis parallel to each reflection surface 172. For example, a rotation axis 176 of the motor 175 is orthogonal to the rotation axis of the photoreceptor drums 11511, 11521, 11531, and 11541.

The motor 175 rotates the polygon mirror 171 at a predetermined speed in a rotational direction CCW. For example, the rotation axis 176 of the motor 175 is parallel to the reflection surface 172 of the polygon mirror 171.

The optical scanning apparatus 116 also includes four pre-deflection optical systems 1601, 1602, 1603, and 1604 and four post-deflection optical systems 1801, 1802, 1803, and 1804.

In FIGS. 3 and 4, the pre-deflection optical systems 1601 and 1602 and the post-deflection optical systems 1801 and 1802 are disposed on the left side of the paper surface, and the pre-deflection optical systems 1603 and 1604 and the post-deflection optical systems 1803 and 1804 are disposed on the right side of the paper surface.

As illustrated in FIG. 4, the pre-deflection optical systems 1601, 1602, 1603, and 1604 respectively guide the light beams BY, BM, BC, and BK respectively emitted from the light sources 1531, 1532, 1533, and 1534 to the optical scanner 170.

The pre-deflection optical system 1601 includes a collimator lens 1621, a diaphragm 1631, and a cylinder lens 1641. Similarly, the pre-deflection optical systems 1602, 1603, and 1604 include collimator lenses 1622, 1623, and 1624, diaphragms 1632, 1633, and 1634, and cylinder lenses 1642, 1643, and 1644, respectively.

The collimator lenses 1621, 1622, 1623, and 1624 convert the light beams BY, BM, BC, and BK emitted from the light sources 1531, 1532, 1533, and 1534 into parallel beams, respectively.

The diaphragms 1631, 1632, 1633, and 1634 shape the light beams BY, BM, BC, and BK that passed through the collimator lenses 1621, 1622, 1623, and 1624, respectively.

The cylinder lenses 1641, 1642, 1643, and 1644 convert the light beams BY, BM, BC, and BK that passed through the diaphragms 1631, 1632, 1633, and 1634 into flat light beams, respectively.

As illustrated in FIG. 3, the post-deflection optical systems 1801, 1802, 1803, and 1804 respectively convert the light beams BY, BM, BC, and BK deflected by the optical scanner 170 into the image forming sections 1151, 1152, 1153, and 1154, respectively.

As illustrated in FIGS. 3 and 4, the post-deflection optical system 1801 includes an image forming optical system for forming an image of the light beam BY on the photoreceptor drum 11511, and the image forming optical system includes an fθ lens 1811 and an fθ lens 1821. Similarly, the post-deflection optical systems 1802, 1803, and 1804 include image forming optical systems that image the light beams BM, BC, and BK on the photoreceptor drum 11521, 11531, and 11541, respectively, and the image forming optical systems include fθ lenses 1812, 1813, and 1814 and fθ lenses 1822, 1823, and 1824, respectively.

The fθ lens 1811 and the fθ lens 1821 cooperate with each other to deflect the light beam BY to be incident perpendicularly on the surface of the photoreceptor drum 11511, and to form an image of the light beam BY on the photoreceptor drum 11511. Similarly, the fθ lenses 1812, 1813, and 1814 and the fθ lenses 1822, 1823, and 1824 cooperate with each other to deflect the light beams BM, BC, and BK to be incident perpendicularly on the surface of the photoreceptor drums 11521, 11531, and 11541, and to form images of the light beams BM, BC, and BK on the surface of the photoreceptor drums 11521, 11531, and 11541.

In FIG. 4, for convenience, the two fθ lenses 1811 and 1812 are drawn in an overlapping manner, and the two fθ lenses 1813 and 1814 are drawn in an overlapping manner. Similarly, the two fθ lenses 1821 and 1822 are drawn in an overlapping manner, and the two fθ lenses 1823 and 1824 are drawn in an overlapping manner. For example, as schematically illustrated in FIG. 3, the two fθ lenses 1811 and 1812 may be configured with one optical element, and the two fθ lenses 1813 and 1814 may be configured with one optical element.

As illustrated in FIG. 3, the post-deflection optical system 1801 includes three folding mirrors 1831, 1841, and 1851 in order to bend an optical path between the two fθ lenses 1811 and 1821. The post-deflection optical system 1802 includes two folding mirrors 1832 and 1842 for bending an optical path between the two fθ lenses 1812 and 1822. The post-deflection optical system 1803 includes two folding mirrors 1833 and 1843 for bending an optical path between the two fθ lenses 1813 and 1823. The post-deflection optical system 1804 includes three folding mirrors 1834, 1844, and 1854 for bending an optical path between the two fθ lenses 1814 and 1824. For example, the two folding mirrors 1831 and 1832 may be configured with one mirror, and the two folding mirrors 1833 and 1834 may be configured with one mirror.

The post-deflection optical system 1801 also includes a synchronous optical system that synchronizes the light beam BY, and the synchronous optical system includes a photodetector 1861, an optical path correction element 1871, and a folding mirror 1881. Similarly, the post-deflection optical systems 1802, 1803, and 1804 respectively include synchronous optical systems for synchronizing the light beams BM, BC, and BK, and these synchronous optical systems respectively include photodetectors 1862, 1863, and 1864, optical path correction elements 1872, 1873, and 1874, and folding mirrors 1882, 1883, and 1884.

In FIG. 4, for convenience, the two photodetectors 1861 and 1862 are drawn in an overlapping manner, and the two photodetectors 1863 and 1864 are drawn in an overlapping manner. Similarly, the two optical path correction elements 1871 and 1872 are drawn in an overlapping manner, and the two optical path correction elements 1873 and 1874 are drawn in an overlapping manner. The two folding mirrors 1881 and 1882 are drawn in an overlapping manner, and the two folding mirrors 1883 and 1884 are drawn in an overlapping manner.

In other words, the optical scanning apparatus 116 includes four scanning optical systems 1501, 1502, 1503, and 1504. The four scanning optical systems 1501, 1502, 1503, and 1504 scan the light beams BY, BM, BC, and BK, respectively, and guide the light beams further to the image forming sections 1151, 1152, 1153, and 1154.

The scanning optical systems 1501, 1502, 1503, and 1504 respectively include the light sources 1531, 1532, 1533, and 1534, the pre-deflection optical systems 1601, 1602, 1603, and 1604, the optical scanner 170, and the post-deflection optical systems 1801, 1802, 1803, and 1804. In other words, the four scanning optical systems 1501 to 1504 include one optical scanner 170 in common.

As illustrated in FIG. 4, the scanning optical systems 1501 and 1502 respectively scan the light beams BY and BM emitted from the light sources 1531 and 1532 in the direction indicated by the arrow SA within the range of the image region IA. As illustrated in FIG. 3, the scanning optical systems 1501 and 1502 also form images of the light beams BY and BM on the surface of the photoreceptor drums 11511 and 11521 of the image forming sections 1151 and 1152. Accordingly, the light beams BY and BM linearly move on the surface of the photoreceptor drums 11511 and 11521. The surfaces of the photoreceptor drums 11511 and 11521 is moved by the rotation of the photoreceptor drums 11511 and 11521. As a result, electrostatic latent images are formed on the surfaces of the photoreceptor drums 11511 and 11521.

The scanning optical systems 1503 and 1504 respectively scan the light beams BC and BK emitted from the light sources 1533 and 1534 in the direction indicated by the arrow SB within the range of the image region IA. As illustrated in FIG. 3, the scanning optical systems 1503 and 1504 also form images of the light beams BC and BK on the surface of the photoreceptor drums 11531 and 11541 of the image forming sections 1153 and 1154. Accordingly, the light beams BC and BK linearly move on the surface of the photoreceptor drums 11531 and 11541. The surfaces of the photoreceptor drums 11531 and 11541 are moved by the rotation of the photoreceptor drums 11531 and 11541. As a result, electrostatic latent images are formed on the surfaces of the photoreceptor drums 11531 and 11541.

The scanning direction of the light beams BY and BM, that is, the direction indicated by the arrow SA is parallel to the rotation axis of the photoreceptor drums 11511 and 11521. Therefore, the moving direction of the surfaces of the photoreceptor drums 11511 and 11521 is perpendicular to the scanning direction of the light beams BY and BM. Similarly, the scanning direction of the light beams BC and BK, that is, the direction indicated by the arrow SB is parallel to the rotation axis of the photoreceptor drums 11531 and 11541. Therefore, the moving direction of the surfaces of the photoreceptor drums 11531 and 11541 is perpendicular to the scanning direction of the light beams BC and BK.

Hereinafter, the scanning direction of the light beams BY and BM and the scanning direction of the light beams BC and BK are referred to as a main scanning direction, and a direction perpendicular to the scanning direction of the light beams BY and BM and the scanning direction of the light beams BC and BK is referred to as a sub-scanning direction.

The optical scanning apparatus 116 includes first cover glasses 1911, 1912, 1923, and 1934, second cover glasses 1921, 1922, 1923, and 1924, and third cover glasses 1931, 1932, 1933, and 1934.

The first cover glasses 1911 to 1914 are disposed on the optical path of the pre-deflection optical systems 1601 to 1604, respectively. The second cover glasses 1921 to 1924 and the third cover glasses 1931 to 1934 are disposed on the optical path of the post-deflection optical systems 1801 to 1804, respectively.

The first cover glasses 1911 to 1914 are disposed between the cylinder lenses 1641 to 1644 and the optical scanner 170, respectively. The second cover glasses 1921 to 1924 are disposed between the optical scanner 170 and the fθ lenses 1811 to 1814, respectively. The third cover glasses 1931 to 1934 are disposed between the fθ lenses 1821 to 1824 and the image forming sections 1151 to 1154, respectively.

The first cover glasses 1911 to 1914 and the second cover glasses 1921 to 1924 are provided to prevent leakage of wind noise when the polygon mirror 171 rotates. The third cover glasses 1931 to 1934 cover the outlets through which the light beams BY, BM, BC, and BK are emitted, in a housing of the optical scanning apparatus 116.

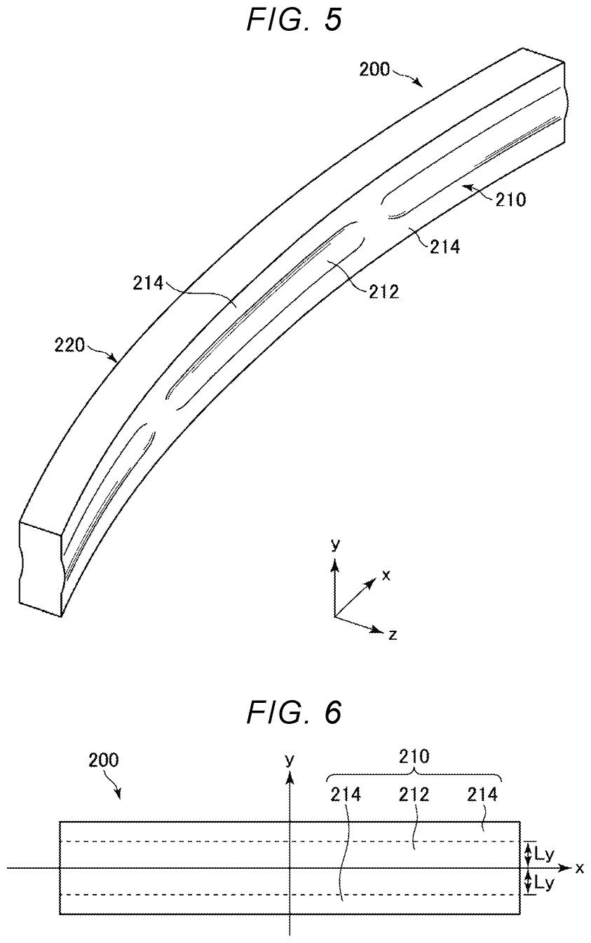

Next, an optical element 200 that can be applied to the fθ lenses 1811 to 1814 and the fθ lenses 1821 to 1824 will be described with reference to FIGS. 5 and 6. FIG. 5 is a perspective view of the optical element 200 that can be applied to the fθ lenses 1811 to 1814 and the fθ lenses 1821 to 1824. FIG. 6 is a plan view of the optical element 200 illustrated in FIG. 5.

For example, the optical element 200 is applied to at least one of the fθ lens 1811 and the fθ lens 1821 of the post-deflection optical system 1801. In other words, the optical element 200 may be applied to one of the fθ lens 1811 and the fθ lens 1821, or may be applied to both the fθ lens 1811 and the fθ lens 1821.

Similarly, the optical element 200 is applied to at least one of the fθ lenses 1812 to 1814 and the fθ lenses 1822 to 1824 in each of the post-deflection optical systems 1802 to 1804. In other words, the optical element 200 may be applied to one of the fθ lenses 1812 to 1814 and the fθ lenses 1822 to 1824 in each of the post-deflection optical systems 1802 to 1804, or both the fθ lenses 1812 to 1814 and the fθ lenses 1822 to 1824.

As illustrated in FIG. 5, the optical element 200 includes a pair of optical surfaces, that is, an optical surface 210 and an optical surface 220, through which the light beam passes. Each of the optical surfaces 210 and 220 gives an optical action to the light beam that passes therethrough (so as to create an optical effect by manipulating the light beam). Hereinafter, the optical surface 210 will be representatively described. In other words, although not described, the optical surface 220 has the same configuration as that of the optical surface 210.

The optical surface 210 includes a first region 212 and a pair of second regions 214. The first region 212 and the second regions 214 are continuous with each other, and the first region 212 is positioned between the pair of second regions 214. The optical element 200 is elongated, and the first region 212 and the second regions 214 extend along the length axis of the optical element 200.

In the post-deflection optical systems 1801 to 1804 in which the optical element 200 is incorporated, the light beam passes through the first region 212. The first region 212, for example, gives negative optical power to the passing light beam at the center portion along the length axis, and gives positive optical power to the passing light beam at the end portion along the length axis.

Here, for convenience, an xyz rectangular coordinate system is set as illustrated in FIG. 5. In other words, the z axis is set parallel to the normal line at the center point of the optical surface 210, the x axis is set perpendicular to the z axis and parallel to the length axis of the optical element 200, and the y axis is set perpendicular to the z axis and the x axis. In the scanning optical systems 1501 to 1504 in which the optical element 200 is incorporated, the x axis corresponds to the main scanning direction and the y axis corresponds to the sub-scanning direction.

In the projection onto the plane perpendicular to the z axis, that is, as illustrated in FIG. 6, the optical surface 210 has a long rectangular outline along the x axis, and accordingly, the first region 212 and the second region 214 also similarly have a long rectangular outline along the x axis.

The first region 212 and the second region 214 are adjacent to each other along the y axis and are smoothly continuous with each other. For example, on the yz plane, at a boundary 216 between the first region 212 and the second region 214, the tangent of the first region 212 and the tangent of the second region 214 match each other.

The absolute value of the maximum curvature of the optical surface 210 is smaller than a predetermined value. While the first region 212 is designed to give an optical action (that is, impart an optical effect) to the passing light beam, the light beam is not supposed to pass through the second region 214 in the first place. Therefore, the absolute value of the maximum curvature of the second region 214 is smaller than the absolute value of the maximum curvature of the first region 212. Since the optical element 200 is applied to the fθ lens, it is needless to say that the absolute value of the curvature of the optical surface 210 along the x axis is smaller than the absolute value of the curvature of the optical surface 210 along the y axis. The absolute value of the curvature of the first region 212 is relatively large at the center portion and at the end portion along the y axis. The absolute value of the curvature of the center portion of the first region 212 along the y axis is smaller than the absolute value of the curvature of the first region 212 along the y axis.

In other words, the absolute value of the maximum curvature of the second region 214 is smaller than the absolute value of the maximum curvature of the first region 212. The absolute value of the curvature of the first region 212 is the largest at end portion, that is, at the boundary 216 along the y axis. The absolute value of the maximum curvature of the first region 212, that is, the absolute value of the curvature of the first region 212 along the y axis at the boundary 216 is smaller than a predetermined value.

In other words, the optical surface 210 has the absolute value of the maximum curvature at the boundary between the first region 212 and the second region 214. The absolute value of the maximum curvature of the optical surface 210 is smaller than a predetermined value.

The predetermined value is an absolute value of the maximum curvature that can be achieved by machining with a tool used for forming the optical surface 210. For example, the optical element 200 is manufactured by cutting an optical element material. Otherwise, the optical element 200 is manufactured by molding by pouring a material such as resin into a gap formed by a pair of molding dies.

When the optical element 200 is manufactured by cutting, the tool used for forming the optical surface 210 is a cutting tool that cuts the optical element material. When the optical element 200 is manufactured by molding, the tool used for forming the optical surface 210 is a cutting tool for cutting the molding die material in order to manufacture the molding die.

The cutting tool is, for example, a so-called tool for cutting. The tool for cutting includes a blade that is rotated with a constant radius. Machining with the tool for cutting is performed by moving a machining target to be cut with respect to the blade that rotates with a constant radius according to the shape of the desired machined surface. Accordingly, the machining target is selectively cut, and the machined surface having a desired shape is formed on the machining target. For example, the movement of the machining target with respect to the blade is controlled in a direction perpendicular and parallel to the rotation axis of the blade.

The absolute value of the maximum curvature of the machined surface that can be formed by such a cutting tool differs depending on the relative moving direction between the cutting tool and the machining target. For example, the absolute value of the maximum curvature is determined corresponding to the rotation radius of the blade in the direction perpendicular to the rotation axis of the blade, and is determined corresponding to the tip end radius of the blade in the direction parallel to the rotation axis of the blade.

The absolute value of the curvature is equal to the reciprocal number of the radius of curvature. Therefore, the evaluation of the absolute value of the curvature is equivalent to the evaluation of the radius of curvature. In other words, the absolute value of the maximum curvature of the machined surface is, that is, the minimum radius of curvature of the machined surface.

Therefore, the absolute value of the maximum curvature of the machined surface is the minimum radius of curvature of the machined surface. The minimum radius of curvature of the machined surface is, for example, 30 mm in the direction perpendicular to the rotation axis of the blade, and 2 mm in the direction parallel to the rotation axis of the blade.

As described above, in the optical element 200, the absolute value of the curvature of the optical surface 210 along the y axis is greater than the absolute value of the curvature of the optical surface 210 along the x axis. Therefore, in the formation of the optical surface 210 of the optical element 200, the width axis of the optical surface 210 is set to the finest machining direction.

Therefore, the absolute value of the maximum curvature that can be achieved by machining with the cutting tool is 1/30=approximately 0.03 [1/mm] in the longitudinal axial direction and ½ [1/mm] in the lateral axial direction.

Here, the direction in which the machining is possible with the minimum radius of curvature, that is, the direction in which the machining is possible with the absolute value of the maximum curvature is referred to as the finest machining direction. Here, the absolute value of the maximum curvature of the machined surface that can be formed by the cutting tool can be said to be the absolute value of the maximum curvature of the machined surface in the finest machining direction.

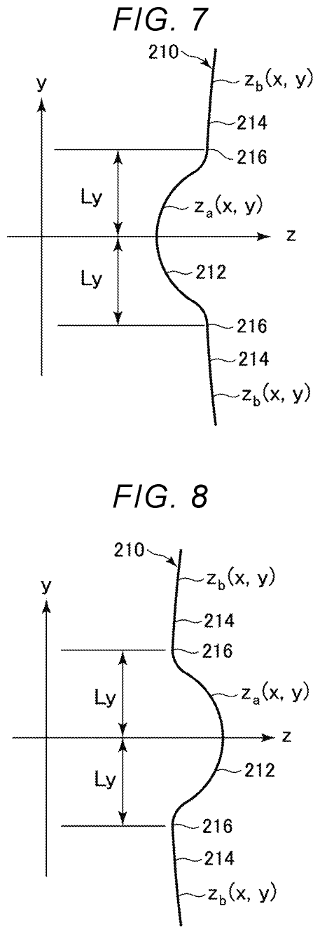

Next, the shape of the optical surface 210 will be described in detail with reference to FIGS. 7 and 8. FIG. 7 illustrates a shape of the optical surface 210 on a section perpendicular to the length axis of the optical element 200 at the center portion of the optical element 200 illustrated in FIG. 5. In other words, FIG. 7 illustrates a curve defined by the intersection of the yz plane and the optical surface 210 at the center portion of the optical element 200. FIG. 8 illustrates a shape of the optical surface 210 on a section perpendicular to the length axis of the optical element 200 at the end portion of the optical element 200 illustrated in FIG. 5. In other words, FIG. 8 illustrates a curve defined by the intersection of the yz plane and the optical surface 210 at the end portion of the optical element 200.

In FIGS. 7 and 8, Ly expresses the distance from the z axis to the boundary 216 between the first region 212 and the second region 214. The first region 212 is expressed by the range of |y|≤Ly. The second region 214 is expressed by the range of |y|>Ly.

The expression z(x, y) that expresses the optical surface 210 is expressed by z(x, y)=zₐ(x, y)=f(x, y)+g(x, y) in the range of the first region 212, that is, Ly. The expression z(x, y) that expresses the optical surface 210 is expressed by z(x, y)=z_{b}(x, y)=f(x, y)+g(x, Ly) in the range of the second region 214, that is, |y|≤Ly.

As described above, the first region 212 and the second region 214 are smoothly continuous with each other at the boundary 216. Therefore, zₐ(x, Ly)=z_{b}(x, Ly), and further, the value at the y=Ly coordinates of the first-order derivative of y of g(x, y) is 0.

For example, zₐ(x, y) is expressed by the following equation.

$${z}_{a} ( x , y ) = \frac{cx \cdot {x}^{2} + cy \cdot {y}^{2}}{1 + \sqrt{1 - ax \cdot {cx}^{2} \cdot {x}^{2} - ay \cdot {cy}^{2} \cdot {y}^{2}}} + {\sum }_{i = 0}^{n} {\sum }_{j = 0}^{m} {a}_{ij} \cdot {x}^{i} \cdot {y}^{j} \cdot ( 1 - \frac{j}{j + k} \cdot {( \frac{y}{Ly} )}^{k} )$$

In the above-described expression, the first term on the right side is f(x, y), and the second term on the right side is g(x, y). In other words, f(x, y) is expressed by the following equation.

$$f ( x , y ) = \frac{cx \cdot {x}^{2} + cy \cdot {y}^{2}}{1 + \sqrt{1 - ax \cdot {cx}^{2} \cdot {x}^{2} - ay \cdot {cy}^{2} \cdot {y}^{2}}}$$

g(x, y) is expressed by the following equation.

$$g ( x , y ) = {\sum }_{i = 0}^{n} {\sum }_{j = 0}^{m} {a}_{ij} \cdot {x}^{i} \cdot {y}^{j} \cdot ( 1 - \frac{j}{j + k} \cdot {( \frac{y}{Ly} )}^{k} )$$

Here, the degree i of x is an integer of 0 or more, that is, i=0, 1, 2, 3, 4, 5, and . . . . The degree j of y is an even number of 0 or more, that is, j=0, 2, 4, 6, and . . . . The degree k of y is an even number of 2 or more, that is, k=2, 4, 6, and . . . .

z_{b}(x, y) is expressed by the following equation.

$${z}_{b} ( x , y ) = \frac{cx \cdot {x}^{2} + cy \cdot {y}^{2}}{1 + \sqrt{1 - ax \cdot {cx}^{2} \cdot {x}^{2} - ay \cdot {cy}^{2} \cdot {y}^{2}}} + {\sum }_{i = 0}^{n} {\sum }_{j = 0}^{m} {a}_{ij} \cdot {x}^{i} \cdot {( Ly )}^{j} \cdot ( 1 - \frac{j}{j + k} \cdot {( \frac{Ly}{Ly} )}^{k} )$$

In other words, z_{b}(x, y) is expressed by the following equation.

$${z}_{b} ( x , y ) = \frac{cx \cdot {x}^{2} + cy \cdot {y}^{2}}{1 + \sqrt{1 - ax \cdot {cx}^{2} \cdot {x}^{2} - ay \cdot {cy}^{2} \cdot {y}^{2}}} + {\sum }_{i = 0}^{n} {\sum }_{j = 0}^{m} {a}_{ij} \cdot {x}^{i} \cdot {( Ly )}^{j} \cdot ( 1 - \frac{j}{j + k} )$$

The first-order derivative of y of g(x, y) is by the following equation.

$$\frac{d}{dy} g ( x , y ) = {\sum }_{i = 0}^{n} {\sum }_{j = 0}^{m} {a}_{ij} \cdot j \cdot {x}^{i} \cdot {y}^{j - 1} \cdot ( 1 - {( \frac{y}{Ly} )}^{k} )$$

Therefore, the value at the y=Ly coordinates of the first-order derivative of y of g(x, y) is 0, as expressed by the following equation.

$$\frac{d}{dy} g ( x , y ) {\vert}_{y = Ly} = {\sum }_{i = 0}^{n} {\sum }_{j = 0}^{m} {a}_{ij} \cdot j \cdot {x}^{i} \cdot {y}^{j - 1} \cdot ( 1 - {( \frac{Ly}{Ly} )}^{k} ) = 0$$

The curvature ρₓ(x, y) of the optical surface 210 along the x axis is expressed by the following equation.

$${ρ}_{x} ( x , y ) = \frac{\frac{{d}^{2} z}{{dx}^{2}}}{{( 1 + \frac{dz}{dx} )}^{\frac{3}{2}}}$$

The curvature ρ_{y}(x, y) of the optical surface 210 along the y axis is expressed by the following equation.

$${ρ}_{y} ( x , y ) = \frac{\frac{{d}^{2} z}{{dy}^{2}}}{{( 1 + \frac{dz}{dy} )}^{\frac{3}{2}}}$$

As described above, the absolute value of the maximum curvature of the optical surface 210 is smaller than a predetermined value. Since the optical element 200 is applied to the fθ lens, it is needless to say that the absolute value of the maximum curvature of the optical surface 210 along the x axis is smaller than the absolute value of the maximum curvature of the optical surface 210 along the y axis. The absolute value of the maximum curvature ρ_{y}(x, y) of the optical surface 210 along the y axis is smaller than the absolute value of the maximum curvature that can be achieved by machining with a cutting tool. When the absolute value of the maximum curvature that can be achieved by machining with a cutting tool is ρ₀, the curvature ρ_{y}(x, y) of the optical surface 210 along the y axis satisfies |ρ_{y}(x, y)|<ρ₀.

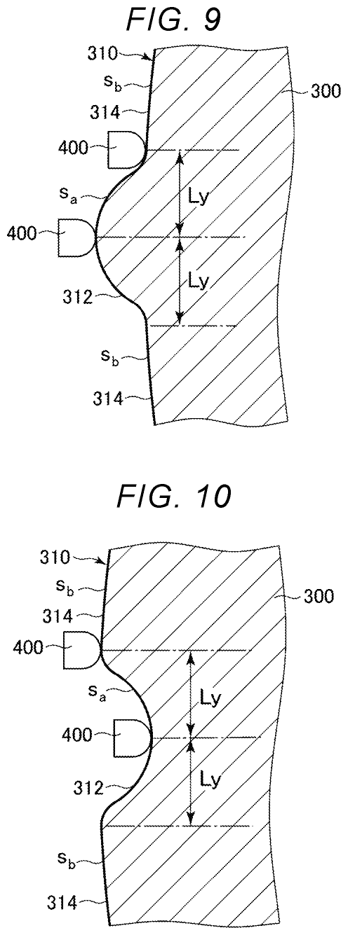

Next, with reference to FIGS. 9 and 10, a molding die 300 for manufacturing the optical element 200 by molding and a cutting tool 400 for manufacturing the molding die 300 will be described. FIGS. 9 and 10 schematically illustrate the molding die 300 for manufacturing the optical element 200 and the cutting tool 400 for manufacturing the molding die 300. FIG. 9 illustrates a sectional shape perpendicular to the length axis of the molding die 300 at the center portion of the molding die 300. FIG. 10 illustrates a sectional shape perpendicular to the length axis of the molding die 300 at the end portion of the molding die 300. In FIGS. 9 and 10, the cutting tool 400 is schematically illustrated as a blade of the above-described cutting tool.

The molding die 300 is one of a pair of molding dies for manufacturing the optical element 200 by molding. The pair of molding dies includes, for example, a male mold and a female mold, or a core and a cavity. The molding die 300 illustrated in FIGS. 9 and 10 expresses, for example, a female mold or a cavity of the pair of molding dies.

The molding die 300 includes a molding surface 310 corresponding to the optical surface 210 of the optical element 200. The molding surface 310 includes a first molding region 312 and a pair of second molding regions 314. The first molding region 312 and the pair of second moldings regions 314 respectively correspond to the first region 212 and the pair of second regions 214 of the optical surface 210. Therefore, the first molding region 312 and the second molding regions 314 are continuous with each other, and the first molding region 312 is positioned between the pair of second moldings regions 314.

The molding surface 310 of the molding die 300 corresponds to the optical surface 210 of the optical element 200. Therefore, the molding surface 310 of the molding die 300 and the optical surface 210 of the optical element 200 have the same shape. However, the unevenness is reversed between the molding surface 310 of the molding die 300 and the optical surface 210 of the optical element 200.

Therefore, the expression sₐ(x, y) that expresses the first molding region 312 of the molding surface 310 is equal to zₐ(x, y). The expression s_{b}(x, y) that expresses the second molding region 314 of the molding surface 310 is equal to zₐ(x, y).

Therefore, the molding surface 310 has the absolute value of the maximum curvature at the boundary between the first molding region 312 and the second molding region 314. The absolute value of the maximum curvature of the molding surface 310 is smaller than the absolute value ρ₀ of the maximum curvature that can be achieved by machining with the cutting tool 400.

Therefore, the molding surface 310 of the molding die 300 can be formed by the cutting tool 400 without any trouble. Here, “without any trouble” means that the following problems do not occur.

When the absolute value of the maximum curvature of the molding surface 310 is greater than ρ₀, and when forming the place having the absolute value of the maximum curvature of the molding surface 310, the cutting tool 400 undesirably comes into contact with a place deviated from the place having the absolute value of the maximum curvature. As a result, a place different from the place intended for machining is cut. This causes the formation of an optical surface which is different from the optical surface 210 of the intended optical element 200.

In at least one embodiment, the optical surface 210 of the optical element 200 has the absolute value of the maximum curvature at the boundary between the first region 212 and the second region 214, and the absolute value of the maximum curvature is smaller than the absolute value ρ₀ of the maximum curvature that can be achieved by machining with the cutting tool 400. Therefore, the above-described problems do not occur. As a result, the optical surface 210 of the optical element 200 is formed as designed by the cutting tool 400.

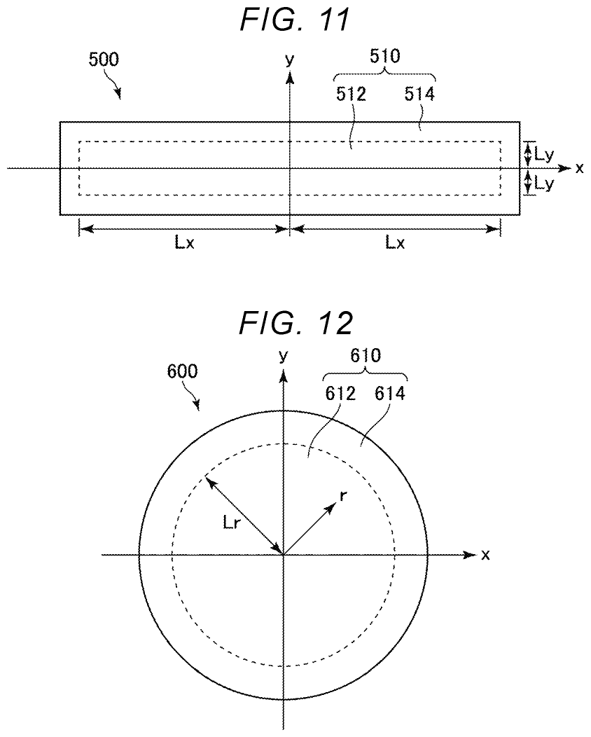

Next, with reference to FIGS. 11 to 13, the outline shapes of optical surfaces 510, 610, and 710 of some optical elements 500, 600, and 700 will be described. FIGS. 11 to 13 illustrate the optical surfaces 510, 610, and 710 in projection onto the xy plane, respectively.

The optical surface 510 of the optical element 500 illustrated in FIG. 11 has an elongated rectangular outline shape along the x axis when being projected onto the xy plane. The optical surface 510 includes a first region 512 and a second region 514. The first region 512 has an elongated rectangular outline shape along the x axis. The second region 514 is positioned around the first region 512.

In FIG. 11, Lx expresses the distance from the z axis to the boundary between the first region 512 and the second region 514 along the x axis. Ly expresses the distance from the z axis to the boundary between the first region 512 and the second region 514 along the y axis. The first region 512 is expressed by the range of |x|≤Lx and |y|≤Ly. The second region 514 is expressed by the range of |x|>Lx or |y|>Ly.

The expression z(x, y) that expresses the optical surface 510 is expressed by z(x, y)=f(x, y)+g(x, y) in the range of the first region 512, that is, |x|≤Lx and |y|≤Ly. The expression z(x, y) that expresses the optical surface 510 is expressed by z(x, y)=f(x, y)+g(x, Ly) in the range of the second region 514, that is, |x|≤Lx and |y|≤Ly. The expression z(x, y) that expresses the optical surface 510 is expressed by z(x, y)=f(x, y)+g(Lx, y) in the range of the second region 514, that is, |x|>Lx and |y|≤Ly.

The value at x=Lx coordinates of the first-order derivative of x of g(x, y) is 0. The value at y=Ly coordinates of the first-order derivative of y of g(x, y) is 0.

The optical surface 510 has the absolute value of the maximum curvature at the boundary between the first region 512 and the second region 514 along the y axis. The absolute value of the maximum curvature of the optical surface 510 is smaller than a predetermined value. Here, the predetermined value is an absolute value of the maximum curvature that can be achieved by machining with a tool used for forming the optical surface 510.

Therefore, the optical element 500 has the same advantages as those of the above-described optical element 200.

The optical surface 610 of the optical element 600 illustrated in FIG. 12 has a circular outline shape when being projected onto the xy plane. The optical surface 610 includes a first region 612 and a second region 614. The first region 612 has a circular outline shape. The second region 614 is positioned around the first region 612. The second region 614 has an annular outline shape. The first region 612 and the second region 614 are positioned at the same center.

In FIG. 12, variable r expresses the distance from the center, that is, the intersection point of the x axis and the y axis. Variable r is expressed by r=(x²+y²)^{1/2}. Variable Lr expresses the distance from the center to the boundary between the first region 612 and the second region 614. The first region 612 is expressed by the range of r≤Lr. In addition, the second region 614 is expressed by the range of r>Lr.

The expression z(r) that expresses the optical surface 610 is expressed by z(r)=f(r)+g(r) in the range of the first region 612, that is, |r|≤Lr. The expression z(r) that expresses the optical surface 610 is expressed by z(r)=f(r)+g(Lr) in the range of the second region 614, that is, |r|>Lr.

The value at r=Lr coordinates of the first-order derivative of r of g(r) is 0.

The optical surface 610 has the absolute value of the maximum curvature at the boundary between the first region 612 and the second region 614. The absolute value of the maximum curvature of the optical surface 610 is smaller than a predetermined value. Here, the predetermined value is an absolute value of the maximum curvature that can be achieved by machining with a tool used for forming the optical surface 610.

Therefore, the optical element 600 has the same advantages as those of the above-described optical element 200.

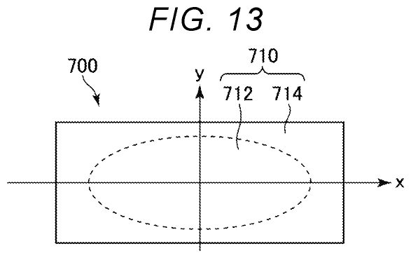

The optical surface 710 of the optical element 700 illustrated in FIG. 13 has an elongated rectangular outline shape along the x axis when being projected onto the xy plane. The optical surface 710 includes a first region 712 and a second region 714. The first region 712 has an elongated rectangular outline shape along the x axis. The second region 714 is positioned around the first region 712.

For example, the expression z(x, y) that expresses the optical surface 710 is expressed by z(x, y)=f(x, y)+g(x, y) in the first region 712. The expression z(x, y) that expresses the optical surface 710 is expressed by z(x, y)=f(x, y)+g(xₐ, yₐ) in the second region 714. Here, (xₐ, yₐ) expresses coordinates of an intersection point between a straight line passing through the point (x, y) in the second region 714 and the center (0, 0), and the ellipse of the boundary between the first region 712 and the second region 714.

The value at the coordinates (xₐ, yₐ) of the first-order derivative of g(x, y) along the straight line passing through the point (x, y) in the second region 714 and the center (0, 0) is 0.

The optical surface 710 has the absolute value of the maximum curvature at the boundary between the first region 712 and the second region 714 along the y axis. The absolute value of the maximum curvature of the optical surface 710 is smaller than a predetermined value. Here, the predetermined value is an absolute value of the maximum curvature that can be achieved by machining with a tool used for forming the optical surface 710.

Therefore, the optical element 700 has the same advantages as those of the above-described optical element 200.

In the description of at least one embodiment, it was described that “the optical surface 220 has the same configuration as that of the optical surface 210”. This means, for example, that the expression that expresses the optical surface 220 is the same as the expression that expresses the optical surface 210. The phrase “the expression that expresses the optical surface 220 is the same as the expression that expresses the optical surface 210” means that the coefficients included in the expressions may be different from each other. This does not deny that the coefficients included in those expressions match each other. The phrase “the expression that expresses the optical surface 220 is the same as the expression that expresses the optical surface 210” also includes a case where the coefficients included in the expressions match each other.

Regarding the expression z(x, y)=f(x, y)+g(x, y) that expresses the optical surface 220, in one specific example, the f(x, y) term expressed a term that expresses a spherical surface. However, the f(x, y) term may be a term that expresses a cylinder surface. The f(x, y) term may be a constant term.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An optical element comprising an optical surface configured to provide an optical effect to a light beam that passes therethrough, the optical surface including:
a first region and a second region smoothly continuous with each other, and
the optical surface having an absolute value of a maximum curvature at a boundary between the first region and the second region, the absolute value of the maximum curvature smaller than a predetermined value.

2. The element according to claim 1, wherein
the predetermined value is an absolute value of the maximum curvature that is achievable by machining with a tool configured to form the optical surface.

3. The element according to claim 1, wherein
a z axis parallel to a normal line at a center point of the optical surface is set, and an x axis and a y axis perpendicular to the z axis and perpendicular to each other are set,
the first region is expressed by a range of |y|≤ Ly, and the second region is expressed by a range of |y|>Ly, and
an expression z(x, y) that expresses the optical surface is
expressed by z(x, y)=f(x, y)+g(x, y) in the range of |y|≤Ly, and
expressed by z(x, y)=f(x, y)+g(x, Ly) in the range of |y|>Ly.

4. The element according to claim 3, wherein
a value at y=Ly coordinates of a first-order derivative of y of g(x, y) is 0.

5. The element according to claim 1, wherein
a z axis parallel to a normal line at a center point of the optical surface is set, and an x axis and a y axis perpendicular to the z axis and perpendicular to each other are set,
the first region is expressed by a range of |x|≤L x and |y|≤Ly, and the second region is expressed by a range of |x|>Lx or |y|>Ly, and
the expression z(x, y) that expresses the optical surface is
expressed by z(x, y)=f(x, y)+g(x, y) in the range of |x|≤Lx and |y|≤Ly,
expressed by z(x, y)=f(x, y)+g(x, Ly) in the range of |x|≤Lx and |y|>Ly, and
expressed by z(x, y)=f(x, y)+g(Lx, y) in the range of |x|>Lx and |y|≤Ly.

6. The element according to claim 5, wherein
a value at x=Lx coordinates of a first-order derivative of x of g(x, y) is 0, and
a value at y=Ly coordinates of the first-order derivative of y of g(x, y) is 0.

7. The element according to claim 1, wherein
a z axis parallel to a normal line at a center point of the optical surface is set, and a distance from the center point on a tangent plane at the center point of the optical surface is set to be r,
the first region is expressed by a range of |r|≤Lr, and the second region is expressed by a range of |r|>Lr, and
an expression z(r) that expresses the optical surface is
expressed by z(r)=f(r)+g(r) in the range of |r|≤Lr, and
expressed by z(r)=f(r)+g(Lr) in the range of |r|>Lr.

8. The element according to claim 7, wherein
a value of a first-order derivative of g(r) in the direction from the center point is 0 at the boundary between the first region and the second region.

9. An optical scanning apparatus comprising:
a light source configured to emit a light beam;
an optical scanner configured to scan the emitted light beam within a plane; and
an image forming optical system configured to form an image of the scanned light beam, the image forming optical system including at least one optical element, the optical element including an optical surface configured to impart an optical effect to a light beam, the optical surface including:
a first region and a second region smoothly continuous with each other, and
an absolute value of a maximum curvature at a boundary between the first region and the second region, the absolute value of the maximum curvature smaller than a predetermined value.

10. The optical scanning apparatus according to claim 9,
wherein the predetermined value is an absolute value of the maximum curvature that is achievable by machining with a tool configured to form the optical surface.

11. The optical scanning apparatus according to claim 9, wherein
a z axis parallel to a normal line at a center point of the optical surface is set, and an x axis and a y axis perpendicular to the z axis and perpendicular to each other are set,
the first region is expressed by a range of |y|≤Ly, and the second region is expressed by a range of |y|>Ly, and
an expression z(x, y) that expresses the optical surface is
expressed by z(x, y)=f(x, y)+g(x, y) in the range of |y|≤Ly, and
expressed by z(x, y)=f(x, y)+g(x, Ly) in the range of |y|>Ly.

12. The optical scanning apparatus according to claim 11, wherein
a value at y=Ly coordinates of a first-order derivative of y of g(x, y) is 0.

13. The optical scanning apparatus according to claim 9, wherein
a z axis parallel to a normal line at a center point of the optical surface is set, and an x axis and a y axis perpendicular to the z axis and perpendicular to each other are set,
the first region is expressed by a range of |x|≤L x and |y|≤Ly, and the second region is expressed by a range of |x|>Lx or |y|>Ly, and
the expression z(x, y) that expresses the optical surface is
expressed by z(x, y)=f(x, y)+g(x, y) in the range of |x|≤Lx and |y|≤Ly,
expressed by z(x, y)=f(x, y)+g(x, Ly) in the range of |x|≤Lx and |y|>Ly, and
expressed by z(x, y)=f(x, y)+g(Lx, y) in the range of |x|>Lx and |y|≤Ly.

14. The optical scanning apparatus according to claim 13, wherein
a value at x=Lx coordinates of a first-order derivative of x of g(x, y) is 0, and
a value at y=Ly coordinates of the first-order derivative of y of g(x, y) is 0.

15. The optical scanning apparatus according to claim 9, wherein
a z axis parallel to a normal line at a center point of the optical surface is set, and a distance from the center point on a tangent plane at the center point of the optical surface is set to be r,
the first region is expressed by a range of |r|≤Lr, and the second region is expressed by a range of |r|>Lr, and
an expression z(r) that expresses the optical surface is
expressed by z(r)=f(r)+g(r) in the range of |r|≤Lr, and
expressed by z(r)=f(r)+g(Lr) in the range of |r|>Lr.

16. The optical scanning apparatus according to claim 15, wherein
a value of a first-order derivative of g(r) in the direction from the center point is 0 at the boundary between the first region and the second region.

17. An image forming apparatus comprising:
a light source that emits a light beam;
an optical scanner configured to scan the emitted light beam within a plane;
an image forming section configured to form an image on an image forming medium based on the imaged light beam; and
an image forming optical system configured to form an image of the scanned light beam, the image forming optical system including at least one optical element, the optical element including an optical surface configured to impart an optical effect to a light beam, the optical surface including:
a first region and a second region smoothly continuous with each other, and
an absolute value of a maximum curvature at a boundary between the first region and the second region, the absolute value of the maximum curvature is smaller than a predetermined value.

18. The image forming apparatus according to claim 17, wherein
a z axis parallel to a normal line at a center point of the optical surface is set, and an x axis and a y axis perpendicular to the z axis and perpendicular to each other are set,
the first region is expressed by a range of |y|≤Ly, and the second region is expressed by a range of |y|>Ly, and
an expression z(x, y) that expresses the optical surface is
expressed by z(x, y)=f(x, y)+g(x, y) in the range of |y|≤Ly, and
expressed by z(x, y)=f(x, y)+g(x, Ly) in the range of |y|>Ly.

19. The image forming apparatus according to claim 18, wherein
a value at y=Ly coordinates of a first-order derivative of y of g(x, y) is 0.

20. The image forming apparatus according to claim 17, wherein
a z axis parallel to a normal line at a center point of the optical surface is set, and an x axis and a y axis perpendicular to the z axis and perpendicular to each other are set,
the first region is expressed by a range of |x|≤L x and |y|≤Ly, and the second region is expressed by a range of |x|>Lx or |y|>Ly, and
the expression z(x, y) that expresses the optical surface is
expressed by z(x, y)=f(x, y)+g(x, y) in the range of |x|≤Lx and |y|≤Ly,
expressed by z(x, y)=f(x, y)+g(x, Ly) in the range of |x|≤Lx and |y|>Ly, and
expressed by z(x, y)=f(x, y)+g(Lx, y) in the range of |x|>Lx and |y|≤Ly.
